(19) United States
(12) Patent Application Publication
(10) Pub. No.: US 2005/0235221 A1
(43) Pub. Date: Oct. 20, 2005

(54) Computer, display device setting method, and program

(75) Inventors: Junichi Asoh, Machida-shi (JP); Takenobu Nakao, Toshima-ku (JP)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/513,048

(22) PCT Filed: Apr. 24, 2003
(86) PCT No.: PCT/JP03/05308

§ 371 Date: Jun. 8, 2005

(30) Foreign Application Priority Data
May 1, 2002 (JP) 2002-130120

(51) Int. Cl. G06F 3/00

(52) U.S. Cl. 715/789; 715/745

(57) ABSTRACT

Configuration and operation information with respect to more than one display devices associated with a computer system can be gathered and stored as profiles. The information preferably includes at least one of information on the number of colors, resolution, and synchronous frequency, information on the power management function and/or screen saver function, and information on which one of multiple connected displays is to be treated as the primary display device. By selecting a profile so as to simultaneously perform various settings on the plurality of display devices, it is possible to easily set and switch between display functions.

### BACKGROUND OF THE INVENTION

1. Field of the Invention

The present invention relates to a computer apparatus such as a notebook computer (notebook PC) or other type of personal computing device, and more particularly to a computer apparatus capable of having multiple display devices connected thereto.

2. Background

Some computers, such as notebook PCs, are able to connect a display device such as a television (TV), projector or an additional, external display. For example, employing a notebook PC, the same image is displayed on an integrated display like a liquid crystal display (LCD) and an external display (like a cathode ray tube (CRT) display); or, one image may be displayed on a multi-display consisting of a plurality of displays. Conventionally, various proposals have been made for such image displays using a plurality of displays. For example, taking a presentation as an example, a computer screen is directly displayed using a projector (a projection type display for projecting onto the screen).

Herein, to enable a display device connected to the computer to be operative, it is required for the user to perform a complex configuration operation. When a CRT display is connected to the notebook PC, the video signal must be output under the conditions adapted to the external CRT as well as the liquid crystal display (LCD) contained in the notebook PC. The user needs to set different synchronous frequencies to two CRT controllers (CRTC) for the LCD and external CRT in a synchronous mode of synchronizing the display, for example. Also, when a large desk top is constructed employing the LCD and the external CRT in a multi-monitor mode, for example, it is required that various different settings be made such as horizontal and vertical synchronizing frequencies, resolution and number of colors for the LCD and the external CRT, in which these complex settings must be made every time the external CRT is connected.

Also, when the screen display for presentation is realized on the multi-monitor, for example, when the presentation is made employing the external display connected to the notebook PC, it is often desired to display only an image different from the image displayed on the LCD of the notebook PC such as an image necessary for the presentation, by removing various kinds of icons and task bars. Also, it is not favorable for the presentation that the display screen transfers to a screen saver screen with a screen saver function, or the display image on the display disappears because of the operation of a power management function.

The present invention has been achieved to solve the above-mentioned technical problems, and it is an object of the invention to easily set up the configuration regarding a display function for a display device connected to the computer apparatus.

Also, it is another object of the invention to easily switch between the settings of the display device making up a multi-monitor in constructing the multi-monitor.

### SUMMARY OF THE INVENTION

In order to accomplish the above objects and others which will become apparent to those skilled in the art, this invention provides a computer apparatus enabling a first display device and at least one external, second display device to be connected. The computer apparatus comprising a profile creation means for creating, as a profile, the configuration information for the second display device that is different from the configuration information for the first display device, a profile storage means for storing the profile created by the profile creation means, and a profile list display means for displaying a list of profiles stored in the profile storage means upon, for example, depressing a hot key so as to allow a user to select the profile. The computer apparatus further comprising a setting means for setting the information for the second display device by invoking the profile stored in the profile storage means based on the profile displayed on the profile list display means and selected by the user, for example, upon depressing a hot key. The profile creation means can create the profile including the configuration information of the first display device. That is, different configuration information or common configuration information for the first display device and the second display device may be included in the profile.

In essence, the invention provides a computer apparatus enabling a plurality of types of display devices to be connected thereto, the computer apparatus comprising a profile creation means for creating, for each type of display device, a profile including an information set for controlling the display device and a profile storage means for storing the profile created by the profile creation means. The computer apparatus further comprising a setting means for setting the information for controlling the display device on the computer apparatus based on the profile by invoking the profile stored in the profile storage means in response to a predetermined operation by the user.

Herein, the profile creation means creates the profile associated with an arbitrary name chosen by the user, wherein the profile list display means displays the list employing the arbitrary name. Also, the profile creation means creates the configuration information including any one of resolution, color depth and refresh rate of the second display device (among other possible configuration settings), and/or creates the configuration information regarding a screen saver function and/or a power management function. The first display device may be a notebook PC in which the main system and the display device are provided within the same housing, or a desktop computer in which the display device is provided within a different housing from the main system.

According to another aspect, the invention provides a computer apparatus comprising a video controller having a plurality of CRT controllers (typically display device controllers), a memory for storing the configuration information of a plurality of display devices as profiles corresponding to the plurality of display devices, the display devices being connected to the plurality of CRT controllers and having different characteristics, and a CPU for controlling the video controller based on the configuration information included in a profile by invoking the profile from the memory in accordance with a designation from a user. Using such profiles, the video controller sets different synchronizing frequencies for the plurality of CRT controllers based on the configuration information when displaying images on the plurality of display devices simultaneously.

Herein, the video controller comprises a first CRT controller and at least a second CRT controller, and the profile stored in the memory includes the information for making any one of a display device connected to the first CRT controller and a display device connected to the second CRT controller a primary display device. This constitution is preferable in that when an application is executed, the display device for simply displaying an application execution screen can be pre-chosen as the primary display device. This display device set as primary is employed as the main display device, in which an application on execution, if simply executed, is displayed on this main display device, and the icons and task bars are directly displayed.

On the other hand, the invention provides a display device configuration method comprising a step of creating the configuration information on each of a plurality of display devices to be connectable to a computer apparatus, a step of storing the created configuration information as a profile for each display device, a step of displaying a list of profiles stored upon, for example, a user depressing a hot key, a step of accepting a designation of the profile from the user from among the profiles displayed in the list, and a step of invoking a specific profile based on the designation, and setting up a corresponding display device based on the profile.

Also, the invention provides a display device configuration method for use with a computer apparatus to display an image on a first display device and an external second display device connected to the computer apparatus, comprising a step of selecting any one of the first display device and the second display device as a primary display device, a step of inputting the configuration information in the first display device and/or the second display device, a step of storing a profile including the information indicating that the primary display device is selected, together with the input configuration information, a step of selecting a screen saver off and/or a power management timer off for the first display device and/or the second display device, and a step of storing the information selected screen saver off and/or power management timer off in the profile.

Moreover, the invention may be grasped as a program that is executed on the computer. That is, the program of the invention enables a computer apparatus enabling a first display device and an external second display device to be connected to perform a creation function of creating the display configuration information on the second display device, a storage function of storing the created display configuration information as a profile on a predetermined storage device, a designation recognition function of displaying a list of profiles including their names upon, for example, a user depressing a hot key and recognizing a designation of the profile from the user using the list, and a setting function of invoking the profile based on the recognition of the designation recognition function, and making the settings of a display on the second display device based on the profile.

Also, the invention provides a program for a computer apparatus enabling a first display device and an external second display device to be connected, the program enabling the computer to perform a primary setting display function of displaying the information for selecting any one of the first display device and the second display device as a primary display device, a setting information display function of displaying the information for inputting the configuration information including, for example, the resolution, color depth and refresh rate (synchronizing frequency) on the first display device and/or the second display device, and a storage function of storing an input of a user based on the information displayed with the primary setting display function and the setting information display function as the profile.

A way of providing these programs may be through the use of the recording medium that stores a program executed by the computer to be readable by the computer. Examples of the recording medium include a floppy disk, a CD-ROM medium, and so on. A program is read by a floppy disk drive (FDD) or a CD-ROM reader, stored in a flash ROM and executed by the computer. Also, these programs may be distributed via a network by a program transmission apparatus to the notebook computer. This program transmission apparatus comprises a memory provided in a server on the host side and storing the program, and program transmission means for providing the program via the network, for example. Moreover, when the computer is provided to the customer, the programs may be installed in the computer.

### BRIEF DESCRIPTION OF THE DRAWINGS

Embodiments of the present invention will be described in some detail in the following specification and with reference to the following figures in which like elements are referred to using like reference numbers and in which:

FIG. 1 is a block diagram showing a hardware configuration of a computer system according to embodiments of the present invention;

FIG. 2 is a diagram showing the processing of a software configuration of embodiments of the present invention;

FIG. 3 is a flowchart showing a process that is performed by a display profile setting/switching component;

FIG. 4 is a flowchart showing a process that is performed by a hot key switching component;

FIG. 5 is a view showing an example of a main screen of a configuration wizard of the present invention;

FIG. 6 is a view showing an example of a wizard screen for setting up the display configuration for a video controller;

FIG. 7 is a view showing an example of a wizard screen for constructing a large desktop with a multi-monitor configuration; and

FIG. 8 is a view showing an example of a user selection screen for allowing the profile to be invoked and switched with a hot key.

### DETAILED DESCRIPTION OF EMBODIMENTS OF THE PRESENT INVENTION

Hereinafter, the present invention will be explained by way of description of exemplary embodiments, however, these embodiments should not be read as limiting the invention's scope which shall be delineated solely by the claims appended hereto. In addition, all combinations of characteristics explained in these embodiments are not necessary for each implementation of the invention.

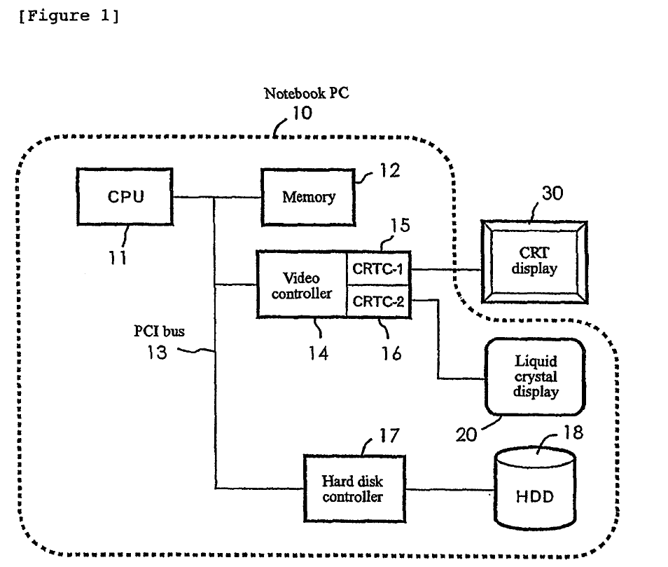

FIG. 1 is a diagram showing the hardware configuration of a computer system according to an embodiment of the present invention. Herein, an external CRT display 30 as a second display device is connected to a notebook PC (personal computer of notebook type) 10 that is a computer. The notebook PC 10 as shown in FIG. 1 is normally equipped with a liquid crystal (or other type of integrated display) display (LCD) 20 as a first display device.

A system of the notebook PC 10 comprises a CPU 11 that operates as a brain of the overall system and executes an OS, the utility programs running under the control of the OS, and various other kinds of programs (not shown) and a memory 12, which is a writable memory, used as a reading area for reading an execution program of the CPU 11, or a working area for writing the processing data of the execution program. The system also includes a PCI (Peripheral Component Interconnect) bus 13, which is a bus capable of transferring data at relatively high speed and which is standardized by such specifications as, for example, a data bus width of 32 bits or 64 bits, a maximum operation frequency of 33 MHz or 66 MHz, and a maximum data transfer rate of 132 MB/sec or 528 MB/sec. The execution programs of the CPU 11 include various kinds of drivers for operating the hardware of the OS and peripheral devices, application programs directed for specific applications, and a firmware such as BIOS (Basic Input/Output System).

A video controller 14 is connected to the PCI bus 13. This video controller 14 processes a drawing instruction from the CPU 11, writes the processed drawing instruction as drawing information into a video memory (not shown), and reads this drawing information from the video memory to output drawing data to a display. The video controller 14 of this embodiment comprises a first CRT controller (CRTC-1) 15 for controlling the external CRT display 30 and a second CRT controller (CRTC-2) 16 for controlling the liquid crystal display 20. Clearly, the controllers referred to as CRT controllers may also comprise controllers for operating other types of displays, as well.

Also, a hard disk controller 17 for controlling a hard disk drive (HDD) 18 that is an external storage unit is connected to the PCI bus 13. In accordance with embodiments of the present invention, the HDD 18 stores a profile associated with each display device, or type of display device, connectable to the computer. The external storage unit such as the HDD 18 is accommodated in a space, called a “media bay” or “device bay”, within the main body of the notebook PC 10, for example. The external storage unit normally equipped may be exclusively replaced with another device such as a FDD or a battery pack.

In accordance with embodiments of the present invention, there is provided a method for momentarily switching to a display device (liquid crystal display 20 connected to the notebook PC 10 or external CRT display 30) in which the profile associated with the display device is loaded by software. The switching software sets up the display resolution, color depth and synchronizing frequency (along with any other applicable configuration settings) corresponding to each display by reading the profile stored in the HDD 18 and sending a series of commands to the video controller 14. As one example, when the CRT display 30 and the liquid crystal display 20 are operated at the same time, the first CRT controller (CRTC-1) 15 and the second CRT controller (CRTC-2) 16 of the video controller 14 are set at different synchronizing frequencies to enable synchronization of the displays independently—all in accordance with the associated profiles.

For example, each profile has associated with it an arbitrary name given by the user when registering the configuration information of each display unit. During a creation process for each profile, a configuration wizard is run to prompt the user to select the required and minimum configuration parameters. Then, after connection to the display is made by pushing down a test button, for example, if it is confirmed that the profile is usable without problem, the profile is registered. This profile includes the information regarding the configuration settings of the display, and the auxiliary information beneficial in the presentation, when practically employed for presentation. For example, the screen saver functions or power management functions can be disabled in the profile, as will be described later. One way of using the profile is to register the profile including a specific function necessary for displaying the screen for a new car, for instance, when a new car screen may be employed many times for sales of the car.

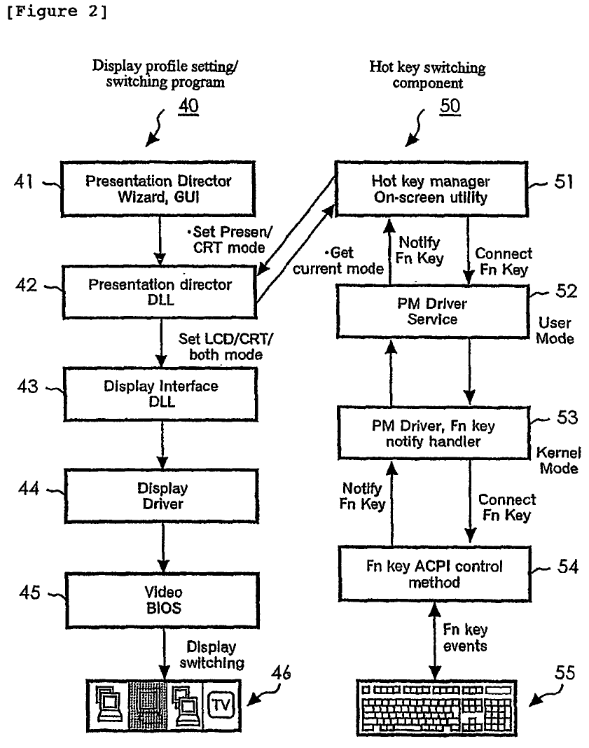

FIG. 2 is a diagram for explaining an embodiment of the present invention configured as software. In this embodiment, two principal software components are provided. One of the components is a display profile setting/switching program 40 that is a program required to create the profile. The other is a hot key switching component 50 enabling the momentary switching. The display profile data is easily set up by these software components, and the configuration of the display selected from the profile is promptly set up by momentarily invoking a list of display profiles already created, employing a hot key, for example. The hot key as used herein is the key used when designating a running program, or calling an add-in soft or a resident program, for example, the Fn+F7 key.

The display profile setting/switching program 40 includes, as a User Mode, a Presentation Director Wizard, GUI 41 that is a configuration wizard for setting the display information, a Presentation Director DLL (Dynamic Link Library) 42, and a Display Interface DLL 43, and as a Kernel Mode, a Display Driver 44 and a Video BIOS 45. The video BIOS 45 controls the input/output of a display switching 46. One series of software from the Presentation Director DLL 42 to the Video BIOS 45 perform a switching process by invoking the profile and setting up the display device.

The Presentation Director Wizard 41 has a function of providing the user interface in creating the setting configuration information of the display device as the profile. When the user performs the Presentation Director Wizard 41, the required display configuration is saved as the profile. When saving the profile, the user pushes down the test button to check whether or not the profile is actually valid. Thereby, the operation is confirmed in advance.

The Presentation Director DLL 42 is a set of common routines for extracting the necessary information in performing the profile created by the user, and making the settings regarding the Display Interface DLL 43. The Display Interface DLL 43 provides a calling source interface required in notifying the settings of the display to the Display Driver 44.

The Display Driver 44 is the driver for making the settings of the display. Also, the Video BIOS 45 is the BIOS (Basic Input/Output System) for internally sending a command to the video controller 14, and controlling the input/output for the display switching 46. The display switching 46 indicates the type of display device connected to the video controller 14. The display device may be the external CRT display 30, the liquid crystal display 20 connected to the main body of the notebook PC 10, an external TV or a projector.

The hot key switching component 50 includes, as the User Mode, a Hot key manager/On-screen utility 51 and a PM Driver Service 52, and as the Kernel Mode, a PM Driver, Fn key notify handler 53, and an Fn key ACPI control method 54 that is the BIOS. The Fn key ACPI control method 54 accepts an event of function (Fn) key made from an input part 55 and notifies it to the PM Driver, Fn key notify handler 53 that is the driver.

The Hot key manager/On-screen utility 51 is the software resident on the memory 12, and provides a user interface having a function of momentarily calling the display configuration Profile created beforehand by the Presentation Director Wizard 41 upon a user depressing the hot key of the notebook PC 10, and displaying it on the screen of the liquid crystal display 20, for example. The Hot key manager/On-screen utility 51 displays a name list of profiles created beforehand by the user on the screen, in which the profile selected by the user is passed via this software to a module on the Presentation Director DLL 42.

The PM Driver Service 52, the PM Driver, Fn key notify handler 53, and the Fn key ACPI control method 54 are a module of device driver and BIOS to notify an event of the key to the Hot key manager/On-screen utility 51 when the user depresses the hot key from the input part 55. Upon depressing the hot key in the input part 55, the BIOS of the Fn key ACPI control method 54 is called to notify the Hot key manager/On-screen utility 51 of the depression of the hot key via the PM Driver, Fn key notify handler 53 and the device driver of the PM Driver Service 52.

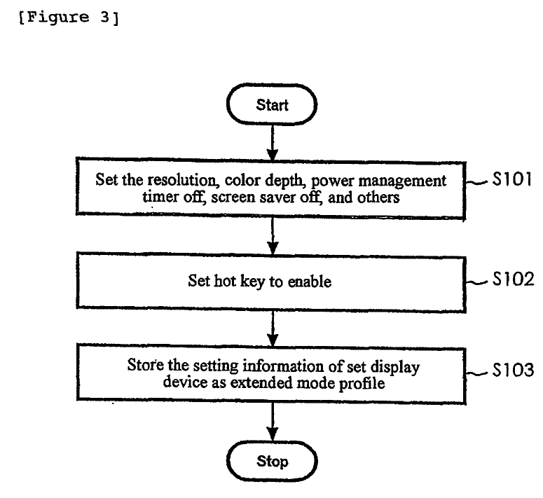

FIG. 3 is a flowchart showing a procedure performed by the display profile setting/switching program 40. First of all, the procedure is started by executing the Presentation Director Wizard 41 to create an extended mode profile. Firstly, various kinds of configuration settings are made, corresponding to the display device to be connected. Herein, the configuration profile of the display device used for presentation, for example, is set up in terms of the resolution, color depth, power management timer off, screen saver off, and other settings (step 101). Then, the hot key (e.g., Fn+F7 key) is set to enable (step 102). With this settings, the set hot key is usable in the extended mode. Thereafter, the setting information of the set-up display device is stored as the extended mode profile (step 103), and the procedure is ended. In this manner, the extended mode profile is set, and the hot key is enabled as the extended mode.

The reason why the power management off and screen saver off are set up at step 101 is to prevent the screen from disappearing due to the power management function that is active if no operation continues for a certain time and prevent the screen from transferring to the screen saver screen due to action of the screen saver function when setting up the display on the CRT display 30 for presentation. In this embodiment, besides the normal setting information of the display device, the display device is set up with those functions. In this embodiment, the “extended mode” is the mode of calling the already created display profile to set up the liquid crystal display 20 that is the first display and the CRT display 30 that is the second display by pushing down the hot key, or set up the power management mode and other modes required for specific purposes such as presentation. By this “extended mode”, the functions can be specialized for specific purposes such as presentation. On the other hand, in a “normal mode”, which is different from the “extended mode”, the hot key performs the normally defined operation. For example, the Fn+F7 key effects a simple switching operation of the display (between LCD display, CRT display, and LCD/CRT concurrent display).

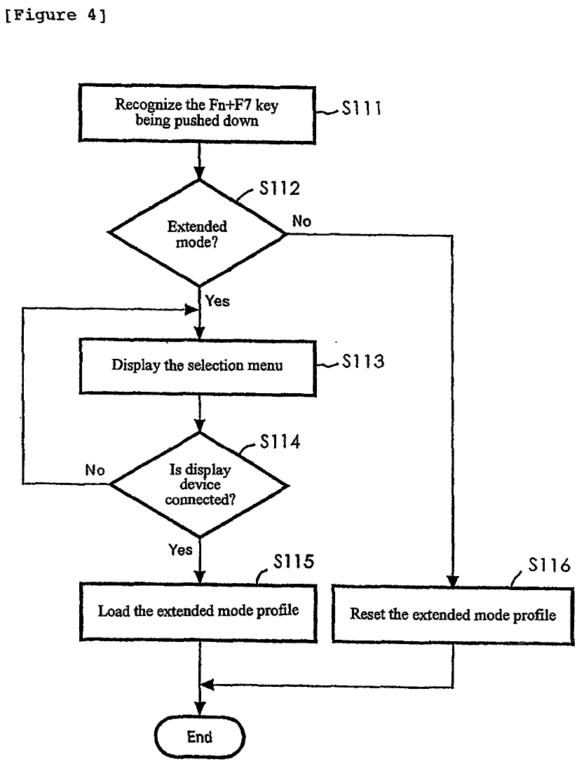

FIG. 4 is a flowchart showing a procedure performed by the hot key switching component 50. First of all, the depression of the Fn+F7 key, for example, is recognized as an event of the function (Fn) key made from the input part 55 via the Fn key ACPI control method 54 that is the BIOS and the PM Driver, Fn key notify handler 53 that is the driver by the Hot key manager/On-screen utility 51 (step 111). Herein, it is determined whether or not the extended mode such as the mode used for presentation is set up (step 112). If the extended mode is not set up, the extended mode profile is reset (step 116), and the procedure is ended.

If the extended mode is set up at step 112, a selection menu, namely, a profile list, is displayed on the screen of the liquid crystal display 20 (step 113). Then, it is determined whether or not the corresponding display device designated by the hot key is connected (step 114). If not connected, its message is indicated, for example, and the selection menu at step 113 is displayed again. If connected, the extended mode profile is loaded (step 115), and then the setting/switching process of the display device is performed. In this manner, the event of the hot key (e.g., Fn+F7 key) is monitored, and if the hot key is depressed, the extended mode profile is acquired.

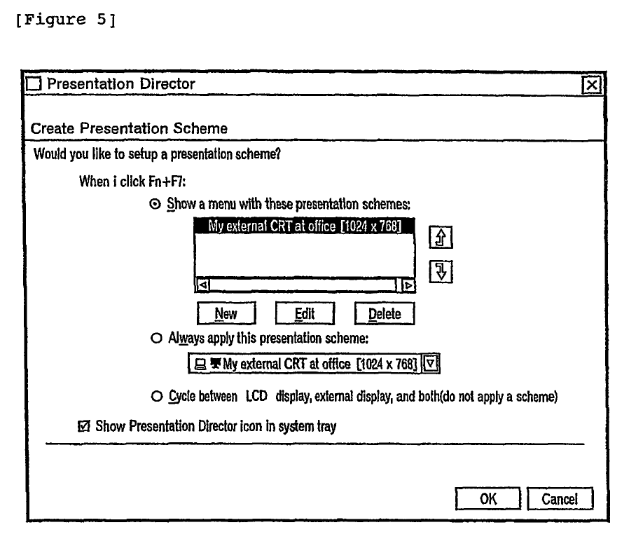

FIGS. 5 to 7 are views showing the screen examples displayed in creating the display configuration profile by the Presentation Director Wizard 41. FIG. 5 is a main screen of the wizard, in which if the profile has been already created, the profile name is displayed as a list. The profile may be changed from this screen.

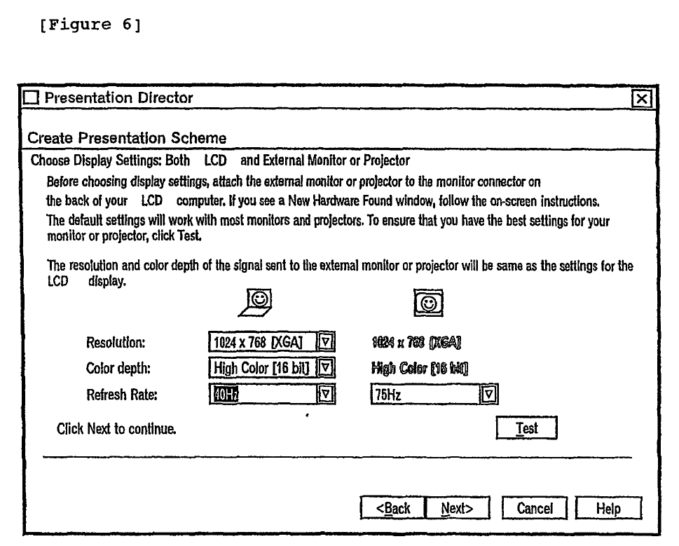

FIG. 6 shows a screen example of the wizard for setting the display configuration for the video controller 14 that is the dual CRT controller. For example, when the liquid crystal display 20 and the CRT display 30 are set up separately for the display configuration by the dual CRT controller having the first CRT controller (CRTC-1) 15 and the second CRT controller (CRTC-2) 16, the settings can be made on the screen display as shown in FIG. 6. Herein, the set-up display is firstly selected, and then configured in terms of the resolution, color depth, refresh rate, etc.

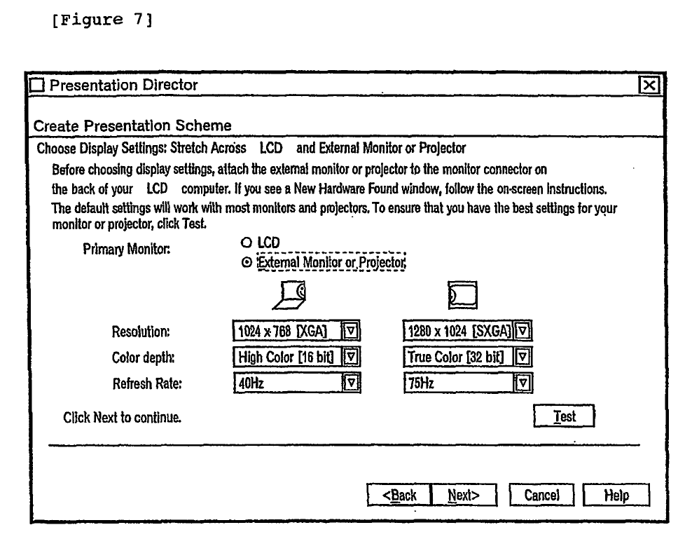

FIG. 7 is a view showing a screen example of the wizard in configuring the large desktop with the multi-monitor. Herein, the settings of configuring the large desktop with the liquid crystal display 20 and the external CRT display 30 are shown. In FIG. 7, various settings are made by selecting the display and designating which of the liquid crystal display 20 and the CRT display 30 will be treated as the primary monitor.

For example, the designation of the primary monitor is made by setting which of the displays is the main (principal) display and which is the sub (subsidiary) display. For example, an application on execution is simply displayed on the display designated as primary, with the icons and task bars being displayed on the screen concurrently. On the other hand, it is not preferred that the icons and task bars be displayed on the display screen for a presentation, but only a window of necessary application may be displayed, if possible. In this embodiment, the primary display device is designated. Thereby, if the display for presentation is set up as subsidiary, for example, the necessary information may be only displayed on the display device for presentation by dragging the image information onto the sub screen, when in practical use.

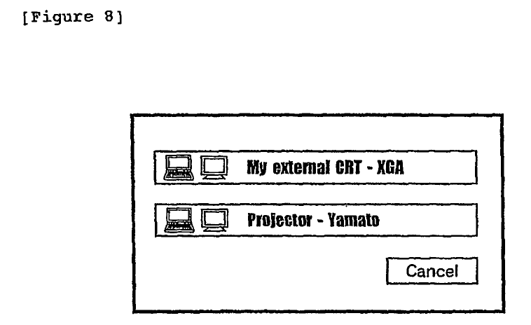

FIG. 8 is a view showing a user selection screen example in which the profile is invoked by the hot key and switched in the hot key switching component 50. In the user interface as shown here, a list of display profiles already created by the Presentation Director Wizard 41 is invoked momentarily, employing the hot key of the notebook PC 10, and the display configuration selected from the profile is settable at once. The profile list as shown in FIG. 8 includes the list of arbitrary names, when the user creates the profile employing arbitrary name, for example. The profile list is displayed on the display screen, when the user pushes down the hot key, for example. The user can select a desired display from the displayed profile list and set up or change the configuration of selected display.

In this way, in this embodiment, the user sets up the external display for presentation, for example, employing the setting wizard, and stores it as the profile, thereby promptly switching the external display connected by the hot key. Also, a two CRT controller (CRTC) synchronous mode is supported, and the system can be switched to the multi-monitor mode, employing the hot key. Moreover, the user can set up a plurality of display configurations, store the setting information for use with these display configurations stored as the profile, and acquire the setting information using the hot key whereby the display configuration is promptly switched at the time of presentation, for example.

Moreover, in this embodiment, by setting up the internal liquid crystal display 20 as primary, for example, the optimal display configuration for performing the presentation is simply implemented, including inhibiting the display of task bars or icons, or displaying the necessary application alone.

The present invention has been explained in some detail be describing one or more exemplary embodiments. However, it is to be understood that the scope of the present invention is not restricted to the range of the above-described embodiments. Those skilled in the relevant arts will readily recognize that various changes or modifications may be made to the described embodiments without departing from the scope and spirit of the present invention.

1. A computer apparatus comprising:
a profile creation means for creating, for each type of display device connectable to said computer apparatus, a profile including a set of configuration information for controlling said display device type;
a profile storage means for storing each said profile; and
a setting means for configuring said display device for operation on said computer apparatus based on said profile by invoking said profile stored in said profile storage means in response to a predetermined operation by a user.

2. The computer apparatus according to claim 1, further comprising a profile list display means for displaying a list of profiles stored in said profile storage means in response to said operation by the user, wherein said setting means configures said display device on the computer apparatus, based on said profile displayed on said profile list display means and selected by the user.

3. The computer apparatus according to claim 2, wherein said profile creation means creates said profile associated with an arbitrary name chosen by the user, wherein said profile list display means displays said list employing said arbitrary name for each profile.

4. The computer apparatus according to claim 1, wherein said configuration information comprises at least one of display resolution, color depth and refresh rate.

5. The computer apparatus according to claim 1, wherein said configuration information comprises a disable screen saver setting.

6. The computer apparatus according to claim 1, wherein said configuration information comprises a disable power management function.

7. A computer apparatus comprising:
a video controller comprising two or more display device controllers;
a memory for storing configuration information for a plurality of display devices, each set of configuration information being a profile corresponding to one of said plurality of display devices, each of said display devices being connected to one of said two or more display device controllers and having different characteristics; and
a control unit for controlling said video controller based on said configuration information included in a profile by invoking said profile from said memory in accordance with a designation from a user;
wherein said video controller sets different synchronizing frequencies to said two or more display device controllers based on said configuration information when displaying images on said plurality of display devices simultaneously.

8. The computer apparatus according to claim 7, wherein said video controller comprises a first display device controller and a second display device controller, and wherein said profile stored in said memory comprises configuration information for designating as a primary display device either a display device connected to said first display device controller or a display device connected to said second display device controller.

9. The computer apparatus according to claim 7, wherein said configuration information stored as said profile in said memory comprises at least a display resolution and color depth for each display device.

10. The computer apparatus according to claim 7, wherein said configuration information stored as said profile in said memory comprises a disable screen saver setting.

11. The computer apparatus according to claim 7, wherein said configuration information stored as said profile in said memory comprises information regarding a power management timer function.

12. A display device configuration method comprising the steps of:
creating configuration information for each of a plurality of display devices connectable to a computer apparatus;
storing said created configuration information as a profile for each display device;
accepting a designation of said profile from a user; and
invoking a specific profile based on said designation, and setting up a corresponding display device based on said profile.

13. The display device setting method according to claim 12, further comprising a step of displaying a list of said stored profiles in response to a predetermined user action, wherein said step of accepting the designation of said profile comprises accepting the designation of said profile by the user from among the profiles displayed in said list.

14. A display device configuration method for use with a computer apparatus to display an image on a first display device and on an external second display device connected to said computer apparatus, comprising the steps of:
selecting one of said first display device and said second display device as a primary display device;
entering configuration information for said first display device and/or said second display device; and
storing a profile comprising said primary display device selection information and further comprising said configuration information.

15. The display device configuration method according to claim 14, further comprising a step of selecting a disable screen saver setting for inclusion in said profile for at least one of said first display device and said second display device. device.

16. The display device configuration method according to claim 14, further comprising a step of selecting a disable power management setting for inclusion in said profile for at least one of said first display device and said second display device.

17. A computer-readable medium comprising computer-readable program instructions effective when executing to: program for a computer apparatus enabling a first display device and an external second display device to be connected, said program comprising:
create display device configuration information for each display device of a plurality of display devices connectable to a computer apparatus;
store, on a predetermined storage device, said configuration information as a profile for each of said display devices;
recognize a user designation of a stored profile for use with a connected display device; and
invoke said designated profile, and configure said connected display device based on said profile.

18. The computer-readable medium according to claim 17, wherein said computer-readable instructions are further effective when executing to display a list of said profiles in response to a predetermined user action, and recognizing the designation of said profile made by the user employing said list.

19. The computer-readable medium according to claim 17 wherein said configuration information comprises a designation of one of said display devices as a primary display device.

20. The computer-readable medium according to claim 17 wherein said configuration information comprises at least one of display resolution, color depth and refresh rate.
